(19) United States
(12) Patent Application Publication
(10) Pub. No.: US 2022/0176491 A1
(43) Pub. Date: Jun. 9, 2022

(54) Manufacturing Method of Welded Pipe and Manufacturing Device of Welded Pipe

(71) Applicant: Hitachi Metals, Ltd., Tokyo (JP)

(72) Inventors: Hironori Yamane, Minato-ku, Tokyo (JP); Takahiro Yokawa, Minato-ku, Tokyo (JP); Makoto Sasaki, Minato-ku, Tokyo (JP)

(73) Assignee: Hitachi Metals, Ltd., Tokyo (JP)

(21) Appl. No.: 17/441,419

(22) PCT Filed: Mar. 25, 2020
(86) PCT No.: PCT/JP2020/013392

§ 371 Date: Sep. 21, 2021

(30) Foreign Application Priority Data
Mar. 27, 2019 (JP) 2019-060259

(51) Int. Cl. B23K 26/282; B21C 37/08; B23K 26/14; B23K 26/00; B23K 26/03; B23K 26/08

(52) U.S. Cl. CPC B23K 26/282; B21C 37/08; B23K 26/1464; B23K 2103/05; B23K 26/032; B23K 26/083; B23K 26/0093

(57) ABSTRACT

Disclosed is a manufacturing method of a welded pipe, which includes: bending a stainless steel strip while conveying the stainless steel strip in one direction to thereby form a pipe; and welding a butting part of the formed pipe.

### TECHNICAL FIELD

The present disclosure relates to a manufacturing method of a welded pipe and a manufacturing device of a welded pipe.

### BACKGROUND ART

There is known a manufacturing method of welded pipes, which comprises forming a metal strip into a pipe shape and then welding a butting part of the formed body. For example, Patent Document 1 mentions the invention of a manufacturing method of welded pipes in which a metal strip is curved by a plurality of rolls while being conveyed, followed by continuously welding its butting part.

Welding methods used to manufacture welded pipes include high-frequency electric resistance welding, arc welding, laser welding, and the like. When the thickness of a pipe wall of a welded pipe is 1.0 mm or more, high-frequency electric resistance welding or laser welding is often used. On the other hand, when the thickness of a pipe wall is less than 1.0 mm, arc welding such as TIG welding, which enables continuous and stable welding, is often used.

In the case of manufacturing a welded pipe using laser welding, if the beam spot diameter at an irradiation position of a laser beam is small, the welding may become insufficient as a butting part of a formed body deviates from the irradiation position. To address this issue, for example, Patent Document 2 mentions the invention of a manufacturing method of welded pipes using a combined heat source of high-frequency heating means and laser welding means to manufacture a welded pipe, in which defocusing is performed such that a beam spot diameter of the laser is 1 mm or more.

In the manufacture of welded pipes, annealing is sometimes performed for the purpose of enhancing the workability of the welded pipe by releasing the stress introduced by plastic deformation during its formation and in its thermal history during welding.

### PRIOR ART DOCUMENT

### Patent Document

Patent Document 1: JP 2016-185560 A

Patent Document 2: JP 8-52512 A

### DISCLOSURE OF THE INVENTION

### Problems to be Solved by the Invention

In the case of using TIG welding for welding when manufacturing welded pipes, it is inevitable that a tungsten electrode is wearing out as the welding time progresses. Owing to this, the tungsten electrode must be replaced by pausing the welding every time a certain time passes, resulting in reduced productivity of welded pipes.

In addition, when TIG welding is used to perform the welding, frost column-like fine columnar crystals, called linear microstructure, may be formed in a weld metal. The linear microstructure refers to a microstructure that includes pores and nonmetallic inclusions in crystal grain boundaries of fine columnar crystals that have grown after welding. Once the linear microstructure is formed, it is difficult to eliminate it even by annealing. When a weld metal having a metal microstructure different from that of a matrix phase is formed in a part of the welded pipe due to the formation of the linear microstructure, there is a concern about its effect on the mechanical strength of the welded pipe.

On the other hand, in the case of laser welding the butting part of a metal strip having a thickness of less than 1.0 mm, the metal microstructure or the like of a weld metal is easily influenced by slight variations in the welding conditions than in the case of a metal strip having a thickness of 1.0 mm or more. Thus, it is difficult in the prior art to stably manufacture welded pipes with a pipe wall thickness of less than 1.0 mm at high speed for a long time using laser welding.

The present disclosure has been made in view of these problems encountered with the conventional methods for manufacturing welded pipes. Therefore, it is an object of the present disclosure to provide a manufacturing method of a welded pipe for welding a metal strip having a thickness of less than 1.0 mm, particularly, a stainless steel strip having a thickness of less than 1.0 mm, using laser welding, which can stably manufacture welded pipes at high speed for a long time such that a weld metal of the welded pipe has a uniform metal microstructure that is hardly different from the metal microstructure of a base metal. In the following, the welded pipe in which the width of the weld metal in a weld zone is narrow while the weld metal and the base metal have the uniform metal microstructure may be simply referred to as “welded pipe that is uniform in the metal microstructure” or “welded pipe that has a uniform metal microstructure”.

### Means for Solving the Problems

First aspect of the present invention is directed to a manufacturing method of a welded pipe, which includes bending a stainless steel strip having a thickness of 0.15 mm or more and 0.45 mm or less while conveying the stainless steel strip in one direction to thereby form a pipe; and welding a butting part of the formed pipe by irradiating the butting part with a laser beam while applying compressive stress to the butting part by using a set of squeeze rolls,

wherein an irradiation position of the laser beam is located on an upstream side in a pipe conveyance direction with respect to a position of a rotation axis of the squeeze roll,

a size of a spot diameter of the laser beam at the irradiation position of the laser beam is 0.60 mm or more and 1.2 mm or less, and

inert gas is blown from a gas nozzle at the butting part irradiated with the laser beam.

Second aspect of the present invention is directed to the manufacturing method of a welded pipe according to the first aspect,

wherein the gas nozzle includes a first gas nozzle and a second gas nozzle having a diameter larger than that of the first gas nozzle, and

the inert gas includes inert gas blown from the first gas nozzle and inert gas blown from the second gas nozzle.

Third aspect of the present invention is directed to the manufacturing method of a welded pipe according to the second aspect,

wherein the irradiation position of the laser beam, a position at which the inert gas is blown from the first gas nozzle, and a position at which the inert gas is blown from the second gas nozzle are arranged at the butting part in this order as viewed from the upstream side in the pipe conveyance direction.

Fourth aspect of the present invention is directed to the manufacturing method of a welded pipe according to any one of the first to third aspects,

wherein a position at which the inert gas is blown from the gas nozzle or the first gas nozzle is located within an area from the irradiation position of the laser beam to the position of the rotation axis of the squeeze roll.

Fifth aspect of the present invention is directed to the manufacturing method of a welded pipe according to any one of the first to fourth aspects,

wherein an angle θ1 formed by a direction in which the inert gas is blown from the gas nozzle or the first gas nozzle and a direction opposite to the pipe conveyance direction is 25 degrees or more and 65 degrees or less.

Sixth aspect of the present invention is directed to the manufacturing method of a welded pipe according to any one of the first to fifth aspects,

wherein a flow rate of the inert gas blown from the gas nozzle or the first gas nozzle is 1.0 liter per minute or more and 20 liters per minute or less.

Seventh aspect of the present invention is directed to the manufacturing method of a welded pipe according to any one of the first to sixth aspects,

wherein a distance d from the irradiation position of the laser beam to the position of the rotation axis of the squeeze roll in a direction parallel to the pipe conveyance direction is within a range of 0.5 mm or more and 5.0 mm or less.

Eighth aspect of the present invention is directed to the manufacturing method of a welded pipe according to any one of the first to seventh aspects,

wherein a position of a laser head for irradiation of the laser beam is located on an upstream side in the pipe conveyance direction with respect to the irradiation position of the laser beam, and a focal point of the laser beam is located between the position of the laser head and the irradiation position of the laser beam.

Ninth aspect of the present invention is directed to the manufacturing method of a welded pipe according to any one of the first to eighth aspects,

wherein reflected light of the laser beam is absorbed by a laser beam receptor.

Tenth aspect of the present invention is directed to the manufacturing method of a welded pipe according to any one of the first to ninth aspects,

wherein the bending of the stainless steel strip is performed using a roll.

According to the manufacturing method of the present disclosure, the butting part is irradiated with the laser beam at the position located on the upstream side with respect to the position of the rotation axis of the squeeze roll, and then the inert gas is blown on the butting part while applying the maximum compressive stress to the butting part by using the set of squeeze rolls, so that a molten pool can be cooled to promote the solidification of weld metal. Furthermore, the generation of fumes from the surface of the molten pool is suppressed.

Eleventh aspect of the present invention is directed to a manufacturing device of a welded pipe, which includes:

means for bending a stainless steel strip having a thickness of 0.15 mm or more and 0.45 mm or less while conveying the stainless steel strip to thereby form a pipe; and means for welding a butting part of the formed pipe by irradiating the butting part with a laser beam while applying compressive stress to the butting part by using a set of squeeze rolls,

wherein an irradiation position of the laser beam is located on an upstream side in a pipe conveyance direction with respect to a position of a rotation axis of the squeeze roll,

a size of a spot diameter of the laser beam at the irradiation position of the laser beam is 0.60 mm or more and 1.2 mm or less, and

the manufacturing device further includes a gas nozzle for blowing inert gas at the butting part irradiated with the laser beam.

### Effects of the Invention

According to the present disclosure, a welded pipe that has a thin pipe wall of less than 1.0 mm in thickness and a weld metal with a narrow width while also having a uniform metal microstructure can be stably manufactured at high speed by the laser welding. In addition, the replacement of tungsten electrodes, which is essential in the conventional TIG welding, becomes no longer necessary. This enables continuous manufacturing of welded pipes over a long time and can also reduce the manufacturing cost of the welded pipes.

### BRIEF DESCRIPTION OF THE DRAWINGS

FIG. 1 is a schematic side view showing an example of a manufacturing device of a welded pipe according to an embodiment of the present invention.

FIG. 2 is a schematic top view showing an example of the manufacturing device of a welded pipe according to the embodiment of the present invention.

FIG. 3 is an example of a photograph of the cross-sectional microstructure of a weld zone of the welded pipe manufactured in the embodiment of the present invention.

FIG. 4 is a photograph of the cross-sectional microstructure of a weld zone of a welded pipe manufactured in the prior art.

### BEST MODE FOR CARRYING OUT THE INVENTION

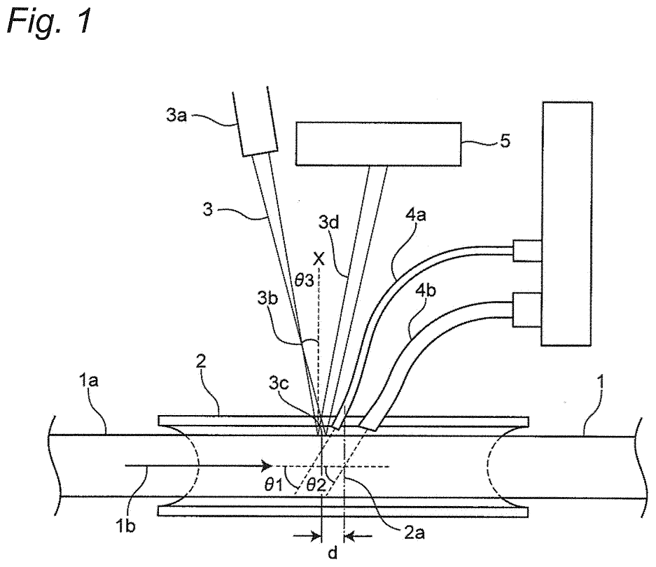

Embodiments for carrying out the present invention will be described in detail below. However, the embodiments mentioned herein are merely examples, and the embodiments of the present invention are not limited to those mentioned herein. In the following first to sixth embodiments, each configuration is described by using the same signs as those in FIG. 1 which schematically illustrates a seventh embodiment to denote some components, but this is simply for ease of understanding, and thus the embodiments for carrying out the present invention are not limited to the one shown in FIG. 1.

### First Embodiment

An embodiment of the present invention (hereinafter sometimes referred to as “first embodiment”) is directed to a manufacturing method of a welded pipe (1), which includes bending a metal strip, particularly a stainless steel strip, that has a thickness of 0.15 mm or more and 0.45 mm or less while conveying it in one direction to thereby form a pipe (1a), and then welding a butting part (1c) of the formed pipe (1a) by irradiating the butting part (1c) with a laser beam (3) while applying compressive stress to the butting part (1c) by using a set of squeeze rolls (2), wherein an irradiation position (3c) of the laser beam is located on an upstream side in a pipe conveyance direction (1b) with respect to a position of a rotation axis (2a) of the squeeze roll (2), the size of the spot diameter of the laser beam (3) at the irradiation position (3c) is 0.60 mm or more and 1.2 mm or less, and inert gas is blown from a gas nozzle (4) at the butting part irradiated with the laser beam (3).

In the first embodiment, a stainless steel strip having a thickness of 0.15 mm or more and 0.45 mm or less is used. Stainless steel is suitable for manufacturing welded pipes for piping, for example, because it has sufficient strength and excellent corrosion resistance even when it is formed thinly. The thickness of the stainless steel strip is 0.15 mm or more, thereby making it possible to ensure the strength of the welded pipe (1), and also to prevent the occurrence of burn-through or porosity during laser welding. Further, the thickness of the stainless steel strip is 0.45 mm or less, thereby enabling the stainless steel strip to be easily formed into the pipe (1a), while preventing insufficient melting or the like during laser welding.

The type of stainless steel that makes up the stainless steel strip may be any type that is easily formed into a pipe and can manufacture a welded pipe with a wall thickness (of a pipe wall) of 0.15 mm or more and 0.45 mm or less by laser welding. Specifically, various types of stainless steel strips listed in the international standard ISO 15510:2014 can be used. As the JIS standard stainless steel strip related to these, various types of austenite-based, ferrite-based, martensite-based, and precipitation-hardened stainless steel strips as specified in the Japanese Industrial Standard JIS G 4304 (“Hot-rolled stainless steel sheet and strip”, Japanese Standards Association, revised Sep. 4, 2015) can be used, but the stainless steel strip is not limited thereto.

In the first embodiment, a stainless steel strip as a metal strip having a thickness of 0.15 mm or more and 0.45 mm or less is bent while being conveyed in one direction to thereby form the pipe (1a). Known methods such as roll forming using a plurality of rolls and shoe forming using a single or plurality of shoes can be used for the bending process. Alternatively, these methods may be combined as appropriate. The use of rolls for the bending process is preferable because the wear of a tool is less and the position of the butting part becomes more stable, compared to the use of shoes. The pipe (1a) obtained by the bending process has a substantially circular cross-section and is shaped to have the butting part (1c) composed of both ends of the stainless steel strip which are butted with each other.

In the first embodiment, compressive stress is applied to the butting part (1c) of the formed pipe (1a) by a set of squeeze rolls (2). The squeeze roll (2) is a cylindrical roll that rotates about the rotation axis (2a) and has, on its outer peripheral surface, a semicircular groove with the same diameter as the outer diameter of the pipe (1a). The set of squeeze rolls (2) is installed such that their rotation axes (2a) are parallel, and by causing the pipe (1a) to pass through the circular groove formed between them, the compressive stress can be applied to the butting part (1c) of the pipe (1a).

In more detail, assuming that the butting part is in the direction of 12 o'clock of a clock on the cross-section of the pipe (1a) cut perpendicular to its central axis, the pipe (1a) is sandwiched by the set of squeeze rolls (2) from the directions of 9 o'clock and 3 o'clock of the clock at the same time, causing both ends of the stainless steel strip constituting the butting part (1c) to be sufficiently butted with each other, whereby the compressive stress is applied to the contact surfaces of the stainless steel strip at the butting part (1c). This compressive stress becomes maximum at the position of a plane including two rotation axes (2a).

In the first embodiment, the butting part (1c) of the formed pipe (1a) is welded by irradiating the butting part (1c) with the laser beam (3) while applying compressive stress thereto by the above-mentioned means. Irradiation of the laser beam (3) is performed by irradiating the butting part (1c) with the laser beam (3) generated from a laser head (3a) having a known light source such as a YAG laser. Various conditions, such as the type, output power, and beam diameter of a light source used for the laser welding and the direction of irradiation of the laser beam (3), can be selected as appropriate according to the results of welding. The maximum speed at which the pipe (1a) formed by the bending process to be subjected to the laser welding is conveyed in the pipe conveyance direction (1b) depends on the output of the laser head (3a). For example, when the output of the laser head (3a) is 2 kilowatts, the pipe (1a) can be laser-welded while being conveyed at a maximum speed of 20 meters per minute.

In the first embodiment, the irradiation position (3c) of the laser beam is located on the upstream side in the pipe conveyance direction (1b) with respect to the position of the rotation axis (2a) of the squeeze roll. The irradiation position (3c) of the laser beam refers to the position where the laser beam (3) hits the surface of the butting part (1c) of the pipe (1a). Since the direction of irradiation of the laser beam (3) is fixed, the irradiation position (3c) does not change unless the position of the pipe (1a) being conveyed changes significantly. The position of the rotation axis (2a) of the squeeze roll refers to the position where the plane including the two rotation axes (2a) is.

In the first embodiment, since the irradiation position (3c) of the laser beam is located on the upstream side in the pipe conveyance direction (1b) with respect to the position of the rotation axis (2a) of the squeeze roll (2), the butting part (1c) of the pipe (1a) absorbs energy of the laser beam (3) at the irradiation position (3c) to form a molten pool. Then, the formed molten pool solidifies in the process of moving the pipe in the pipe conveyance direction (1b) to become weld metal. In this process of the formation and solidification of the molten pool, the compressive stress applied to the butting part becomes maximum when the butting part passes through the position of the rotation axis (2a) of the set of squeeze rolls (2). The weld metal is formed in a state where both ends of the stainless steel strip at the butting part are butted firmly with each other by this maximum compressive stress, thereby suppressing the occurrence of welding defects such as porosity.

Assuming that d is the distance measured from the irradiation position (3c) of the laser beam to the position of the rotation axis (2a) of the squeeze roll in the direction parallel to the pipe conveyance direction (1b), the range of d is preferably 0.5 mm or more and 5.0 mm or less. When d is 0.5 mm or more, the butting part can be melted to form a molten pool before the compressive stress received from the squeeze roll (2) becomes maximum. When d is 5.0 mm or less, the compressive stress received from the squeeze roll (2) can be made maximum before the molten pool is completely solidified. The more preferred range of d is 1.0 mm or more and 4.0 mm or less.

In the first embodiment, the size of the spot diameter of the laser beam (3) at the irradiation position (3c) is 0.60 mm or more and 1.2 mm or less. The spot diameter of the laser beam (3) refers to the diameter of the laser beam (3) on the cross-section perpendicular to its traveling direction. Since the shape of the laser beam (3) is usually cylindrical or conical, its cross-sectional shape becomes a circle. Depending on the direction of irradiation of the laser beam (3), the shape of a surface actually irradiated with the laser beam (3) becomes elliptical. The surface to be irradiated with the laser beam (3) is the outer peripheral surface of the pipe (1a), which is precisely a part of the side surface of a cylinder. Nevertheless, in the embodiment of the present invention, the “spot diameter” strictly refers to the diameter of the laser beam (3) on the cross-section perpendicular to the traveling direction thereof at the irradiation position (3c).

As the spot diameter of the laser beam (3) becomes smaller, the energy of the laser beam (3) is concentrated on the spot, resulting in higher energy density there. On the other hand, as the spot diameter of the laser beam (3) becomes larger, the energy of the laser beam (3) is dispersed, resulting in lower energy density there. In the first embodiment, the size of the spot diameter of the laser beam (3) at the irradiation position (3c) is 0.60 mm or more, which prevents the molten pool from burning through or the molten metal from evaporating and disappearing all at once due to an extremely high energy density of the laser beam (3). Further, the size of the spot diameter is 1.2 mm or less, which prevents the melting of the butting part from becoming insufficient due to an extremely low energy density of the laser beam (3). The preferred size of the spot diameter of the laser beam (3) at the irradiation position (3c) is 0.80 mm or more and 1.0 mm or less.

To set the size of the spot diameter of the laser beam (3) at the irradiation position (3c) within the above-mentioned range, means for adjusting the distance between the laser head (3a) and the irradiation position (3c) or adjusting the focal length of a focusing lens or parabolic mirror of the laser head (3a) can be employed. In the case where the laser head (3a) employs a lens-based focusing system, laser light generated by a light source is guided by an optical fiber to a collimator lens, and consequently it is applied as the laser beam (3) to the outside through the focusing lens. Once the laser beam (3) converges to a focal point (3b) of the focusing lens so that the laser beam has the size of the diameter of the optical fiber, it then expands again. Therefore, the size of the spot diameter of the laser beam (3) at the irradiation position (3c) can be adjusted within the above-mentioned range by adjusting the position of a subject to be irradiated from the focal point (3b) in the front-back direction with respect to the light traveling direction.

In the first embodiment, the inert gas is blown from the gas nozzle (4) at the butting part irradiated with the laser beam (3). The butting part irradiated with the laser beam (3) absorbs energy of the laser beam and is melted to form a molten pool. Then, the molten pool is cooled and solidified to become the weld metal. If the cooling rate is slow, the molten pool passes through the position of the rotation axis (2a) of the squeeze roll (2) before it solidifies, and thus the compressive stress received from the squeeze roll (2) cannot be made maximum before the molten pool is completely solidified. When the speed of conveyance of the pipe (1a) is slowed down for the purpose of ensuring time for solidification, the production efficiency of the welded pipe is reduced. Therefore, in the first embodiment, the timing of cooling and solidifying of the molten pool and the timing of applying the compressive stress by using the squeeze roll (2) are synchronized by blowing the inert gas from the gas nozzle (4) to the butting part irradiated with the laser beam (3), thereby making it possible to manufacture the welded pipe (1) at a high speed. Further, in the first embodiment, the formation and solidification of the molten pool are completed in a short time under an inert atmosphere, so that the welded pipe (1) with a uniform metal microstructure can be manufactured without forming the above-mentioned linear microstructure in the weld metal.

In order to easily synchronize the timing of cooling and solidifying of the molten pool and the timing of applying the compressive stress by using the squeeze roll (2), the position at which the inert gas is blown from the gas nozzle (4) is preferably located within an area from the irradiation position of the laser beam to the position of the rotation axis of the squeeze roll.

Blowing the inert gas onto the butting part (1c) is also effective in preventing generation of fumes. The fume refers to metal vapor generated by evaporation of the molten metal from the surface of the molten pool. In the first embodiment, since the size of the spot diameter of the laser beam (3) is set to 0.60 mm or more, the area of the molten pool becomes larger, compared to the laser beam having a smaller spot diameter, resulting in more fumes being generated accordingly. Fumes can adhere to the surface of the weld metal, causing a reduction in the quality of the weld metal, or adhere to and deposit on the surface of the squeeze roll (2), thus interfering with the continuous operation. In addition, the fumes can be excited by the laser beam (3) to generate plasma, which could also reduce the energy efficiency of the laser beam (3). In the first embodiment, the temperature of the surface of the molten pool is decreased quickly by blowing the inert gas onto the surface of the molten pool, thereby making it possible to prevent the generation of fumes.

Any inert gas may be used as long as it can prevent oxidation of the molten pool and weld metal. For example, inert gas such as argon and helium can be used. Nitrogen may be used as the inert gas. The position at which the inert gas is blown may be anywhere in the butting part irradiated with the laser beam (3), and for example, this position may be the irradiation position (3c) of the laser beam. The position at which the inert gas is blown refers to the position where the flow of inert gas firstly hits the butting part (1c).

The size of the area over which the inert gas is blown from the gas nozzle (4) can be equal to or larger than that of the spot diameter of the laser beam (3) at the irradiation position (3c), for example. In this case, the inert gas hits the entire surface of the molten pool, thus improving the cooling efficiency. When the flow of inert gas hits a wide area of the welded pipe (1), the position at which the inert gas is blown refers to the position of the center of the flow of inert gas emanating from the tip of the gas nozzle (4), specifically, the position where the line extending from the central axis of the inner diameter of the gas nozzle (or the line extending from the tangent line at the tip of the gas nozzle in the case of a curve) intersects the surface of the pipe.

Since the main purpose of blowing the inert gas is to cool the surface temperature of the molten pool, it is necessary to blow a sufficient amount of inert gas such that heat on the surface of the molten pool is released by the flow of inert gas. However, if the flow of inert gas is extremely intense, the surface of the molten pool may become uneven, or in the worst case, part of the metal in the molten pool may be blown away to create a hole. Thus, it is preferable to adjust the flow rate of inert gas within an appropriate range. The preferred flow rate of the inert gas blown from the gas nozzle (4) is 1.0 liter per minute (L/min) or more and 20 liters per minute or less.

An angle θ1 formed by the direction in which the inert gas is blown from the gas nozzle (4) at the butting part irradiated with the laser beam (3) and the direction opposite to the pipe conveyance direction (1b) is preferably 25 degrees or more and 65 degrees or less. Here, the direction in which the inert gas is blown from the gas nozzle (4) refers to the direction in which the inert gas is blown away from the tip of the gas nozzle (4), more specifically, the direction in which the central axis of the inner diameter of the gas nozzle (4) is extended (the direction in which the tangent line at the tip is extended in the case of a curve). When the angle θ1 is 25 degrees or more, the inert gas is blown toward the surface of the molten pool, which can easily achieve the cooling effect. If the inert gas is blown only for the purpose of removing the generated fumes, the angle at which the inert gas is blown may be in the direction parallel to the surface of the molten pool. However, in the first embodiment, it is preferable to blow the inert gas with an inclination of angle θ1 of 25 degrees or more so as to cool the molten pool. When the angle θ1 is 65 degrees or less, heat exchange between the molten pool and the inert gas is likely to occur because the direction forming the angle is opposite to the pipe conveyance direction (1b). The more preferred angle θ1 is 30 degrees or more and 50 degrees or less.

As described above, in the first embodiment, the stainless steel strip as the metal strip having a thickness of 0.15 mm or more and 0.45 mm or less is bent while being conveyed in one direction to thereby form the pipe (1a), and then the butting part (1c) of the formed pipe (1a) is welded by irradiating the butting part (1c) with the laser beam (3) while applying compressive stress to the butting part (1c) by using the set of squeeze rolls (2), wherein the irradiation position (3c) of the laser beam and the size of the spot diameter are limited, and the inert gas from the gas nozzle (4) is blown at the butting part irradiated with the laser beam (3), so that the welded pipes (1) having the uniform metal microstructure can be stably manufactured at high speed for a long time while preventing the generation of fumes.

### Second Embodiment

Another embodiment of the present invention (hereinafter sometimes referred to as “second embodiment”) is directed to a manufacturing method of a welded pipe in which the inert gas in the first embodiment includes inert gas blown from a first gas nozzle (4a) and inert gas blown from a second gas nozzle (4b) that has a diameter larger than that of the first gas nozzle (4a). That is, in the second embodiment, the inert gas that is blown at the butting part irradiated with the laser beam (3) is blown from at least two locations: the first gas nozzle (4a); and the second gas nozzle (4b) having a diameter larger than that of the first gas nozzle. The “diameter” of the gas nozzle as used in the embodiments of the present invention refers to the inner diameter of the pipe constituting the gas nozzle.

In the second embodiment, as in the first embodiment, any inert gas may be used as long as it can prevent oxidation of the molten pool and weld metal. For example, inert gas such as argon and helium can be used. Nitrogen may be used as the inert gas. The inert gas blown from the first gas nozzle (4a) and the inert gas blown from the second gas nozzle (4b) may be the same type of inert gas or different types of inert gas.

Similar to the inert gas in the first embodiment, the inert gas blown from the first gas nozzle (4a) is blown in order to promote and control the cooling and solidifying of the molten pool to fully demonstrate the effect of applying the compressive stress using the squeeze roll (2), thereby enhancing the production efficiency of the welded pipe (1) with the uniform metal microstructure, and further to prevent the generation of fumes. Therefore, the preferred conditions for blowing the inert gas from the first gas nozzle (4a) are the same as those for blowing the inert gas from the gas nozzle (4) in the first embodiment.

Meanwhile, the inert gas from the second gas nozzle (4b) is blown in order to prevent air from being entrained in the flow of inert gas blown from the first gas nozzle (4a). For this purpose, the second gas nozzle (4b) is configured so that its diameter is larger than that of the first gas nozzle (4a), allowing the flow velocity of the inert gas therefrom to be slower than that of the inert gas blown from the first gas nozzle (4a). This can form, around the first gas nozzle (4a), a non-oxidizing atmosphere filled with the inert gas blown from the second gas nozzle (4b). In such a case, no air is entrained in the flow of inert gas blown from the first gas nozzle (4a), which can prevent the oxidation of the molten pool and weld metal more reliably. The respective diameters of the first gas nozzle (4a) and the second gas nozzle (4b) are not particularly limited as long as they satisfy the above-mentioned relationship. The diameter of the first gas nozzle (4a) can be, for example, 2.0 to 4.0 mm, while the diameter of the second gas nozzle (4b) can be, for example, 6.0 to 12 mm.

The position at which the inert gas is blown from the second gas nozzle (4b) is preferably set so that the atmosphere around the first gas nozzle (4a) can be an inert gas atmosphere. Therefore, the position at which the inert gas is blown from the second gas nozzle (4b) only needs to be in the vicinity of the position at which the inert gas is blown from the first gas nozzle (4a), and does not have to be the butting part irradiated with the laser beam (3). The direction in which the inert gas is blown from the second gas nozzle (4b) can be a randomly selected direction.

### Third Embodiment

Another embodiment of the present invention (hereinafter sometimes referred to as “third embodiment”) is directed to a manufacturing method of a welded pipe in which the irradiation position (3c), the position at which the inert gas is blown from the first gas nozzle (4a), and the position at which the inert gas is blown from the second gas nozzle (4b) are arranged in this order at the butting part (1c) of the second embodiment as viewed from the upstream side in the pipe conveyance direction. In the case of such an arrangement, the first gas nozzle (4a) is located near the irradiation position (3c) on the downstream side in the pipe conveyance direction (1b), while the second gas nozzle (4b) is located on the further downstream side thereof.

In the above-mentioned arrangement, the inert gas is blown from the first gas nozzle (4a) at the butting part irradiated with the laser beam (3), and the inert gas is then blown from the second gas nozzle (4b) on the opposite side to the irradiation position (3c) across the first gas nozzle (4a). Thus, the inert gas is blown from the second gas nozzle (4b) on the rear side in the direction in which the inert gas is blown from the first gas nozzle (4a). Then, the entire surrounding gas to be entrained into the inert gas blown from the first gas nozzle is composed of the inert gas blown from the second gas nozzle (4b). Consequently, there is no air entrainment, so that the oxidation of the molten pool and weld metal can be prevented more reliably.

In the third embodiment, an angle θ2 formed by the direction in which the inert gas is blown from the second gas nozzle (4b) and the direction opposite to the pipe conveyance direction (1b) is preferably 10 degrees or more and 50 degrees or less. Here, the direction in which the inert gas is blown from the second gas nozzle (4b) is defined in the same manner as the direction in which the inert gas is blown from the above-mentioned gas nozzle (4). If the angle θ2 is 10 degrees or more, the inert gas hits the butting part irradiated with the laser beam (3), which has the effect of further cooling the butting part that has been cooled by the inert gas blown from the first gas nozzle (4a). If the angle θ2 is 50 degrees or less, most of the inert gas blown from the second gas nozzle (4b) flows toward the tip of the first gas nozzle (4a), thus enabling a non-oxidizing atmosphere to be easily formed around the first gas nozzle (4a). The more preferred range of the angle θ2 is 15 degrees or more and 35 degrees or less.

If the angle θ2 is smaller than the above-mentioned angle θ1, it is preferable because the gas blown from the second gas nozzle is directed toward the position at which the inert gas is blown from the first gas nozzle. In order to avoid contact with the welded pipe (1), preferably, the tip of the second gas nozzle (4b) is processed to be inclined, i.e., such that the inclination of a plane including the tip of the second gas nozzle (4b) is not perpendicular to the blowing direction of the inert gas, but close to the pipe conveyance direction (1b).

### Fourth Embodiment

Another embodiment of the present invention (hereinafter sometimes referred to as “fourth embodiment”) is directed to the manufacturing method of a welded pipe according to the first, second, or third embodiment in which the position of the laser head (3a) is located on the upstream side in the pipe conveyance direction (1b) with respect to the irradiation position (3c), and the focal point (3b) of the laser beam is located between the position of the laser head (3a) and the irradiation position (3c). If the direction of irradiation of the laser beam (3) is supposed to be the X direction perpendicular to the butting part (1c) of the pipe (1a), reflected light (3d) that has reflected at the butting part may enter the laser head (3a) again to damage the laser head (3a). Therefore, the direction of irradiation of the laser beam (3) is preferably the direction that is slightly shifted from the X direction perpendicular to the butting part of the pipe (1a), for example, by setting an angle θ3 from the X direction perpendicular to the butting part (1c) to the direction opposite to the pipe conveyance direction (1b) to 10 degrees or more, thereby preventing the reflected light (3d) from entering the laser head (3a) again. The above-mentioned angle θ3 is also referred to as the angle formed by the direction of irradiation of the laser beam (3) and the X direction perpendicular to the butting part (1c) or the pipe conveyance direction (1b). The above-mentioned angle θ3 can be, for example, 45 degrees or less.

In this case, there are two methods: one method of setting the position of the laser head (3a) on the upstream side in the pipe conveyance direction (1b) with respect to the irradiation position (3c); and the other method of conversely setting the position of the laser head (3a) on the downstream side. In the case of adopting the latter method, the laser beam (3) with high energy irradiated from the laser head (3a) passes through near the first gas nozzle (4a), for example, which may damage the first gas nozzle (4a). Therefore, the fourth embodiment prevents the laser beam (3) with high energy from passing through near the gas nozzle (4) by disposing the laser head (3a) on the upstream side in the pipe conveyance direction (1b) with respect to the irradiation position (3c).

In order to adjust the size of the spot diameter of the laser beam (3) at the irradiation position (3c) to 0.60 mm or more and 1.2 mm or less, it is necessary to shift the irradiation position (3c) from the position of the focal point (3b) of the laser beam as mentioned above. In this case, there are two adjustment methods: one method of positioning the irradiation position (3c) closer toward the laser head (3a) than the focal point (3b) of the laser beam; and the other method of conversely positioning the irradiation position (3c) farther from the laser head (3a) than the focal point (3b) of the laser beam as illustrated in FIG. 1.

In the case of adopting the former method, the position of the focal point (3b) becomes the position of the reflected light (3d) reflected at the irradiation position (3c), and this position is located on the downstream side in the pipe conveyance direction (1b) with respect to the irradiation position (3c). At the location of the focal point (3b), the reflected light (3d) is throttled into a size equal to that of the optical fiber, resulting in the high light energy density. Then, the temperature in the surroundings of the focal point (3b) may rise due to scattering of the laser beam (3) by air and dust, which may damage the first gas nozzle and the like. Therefore, in the fourth embodiment as in the above-mentioned latter method, the focal point (3b) of the laser beam is present between the position of the laser head (3a) and the irradiation position (3c), and the focal point (3b) of the laser beam with high energy density is not located near the first gas nozzle.

### Fifth Embodiment

Another embodiment of the present invention (hereinafter sometimes referred to as “fifth embodiment”) is directed to the manufacturing method of a welded pipe according to any one of the first to fourth embodiments in which the reflected light (3d) of the laser beam is absorbed by a laser beam receptor (5). As mentioned above, the angle of the irradiation of the laser beam (3) is preferably set to the angle θ3 that is formed by being slightly shifted from the X direction perpendicular to the butting part (1c) of the pipe (1a), thereby preventing the reflected light (3d) directed toward the laser head (3a) from entering the laser head (3a) again. When the butting part (1c) of the pipe (1a) formed of a stainless steel strip is irradiated with the laser beam (3), only part of the laser beam (3) is absorbed by the stainless steel strip, while most of the light of the laser beam (3) is reflected by the surface of the stainless steel strip. For the stainless steel strip, it is considered that about 65% of incident light is reflected.

The reflected light (3d) has slightly lower energy, compared to the laser beam (3) emitted from the laser head (3a), but still retains high energy. Consequently, a structure located in an optical path of the reflected light (3d) may be damaged. Therefore, in the fifth embodiment, the reflected light (3d) of the laser beam is absorbed by the laser beam receptor (5) to thereby prevent damage to the structure. The laser beam receptor (5) can be made of metal having a high melting point, such as iron, for example. Since the laser beam receptor (5) absorbs the energy of the reflected light (3d), leading to an increase in its temperature, it is preferable to cool the laser beam receptor (5) by circulating cooling water therein. The surface of the laser beam receptor (5) is preferably subjected to a black surface treatment so as to easily absorb the reflected light (3d). When the surface of the laser beam receptor (5) easily absorbs the reflected light (3d), it can prevent the reflected light (3d) from being reflected again at the surface of the laser beam receptor (5).

According to the manufacturing method of a welded pipe related to the present disclosure described above, welded pipes with the occurrence of welding defects sufficiently suppressed can be stably manufactured at high speed for a long time by the laser welding. In addition, the replacement of tungsten electrodes, which is essential in the conventional TIG welding, becomes no longer necessary. This enables continuous manufacturing of welded pipes over a long time and can also reduce the manufacturing cost of the welded pipes.

According to the first to fifth embodiments mentioned above, welded pipes in which discoloration due to oxidation specific to the stainless steel strip is suppressed can be obtained even without the bright annealing mentioned above. In particular, as mentioned in the second to fifth embodiments, according to the manufacturing method using the second gas nozzle as well as the first gas nozzle, welded pipes in which discoloration due to oxidation is suppressed can be obtained even without the bright annealing mentioned above.

### Sixth Embodiment

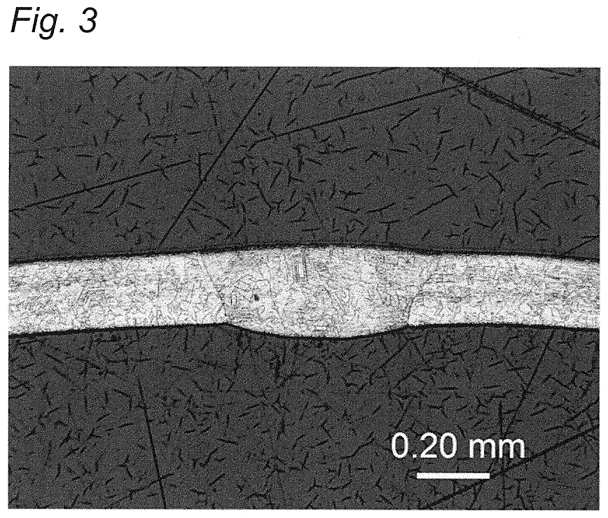

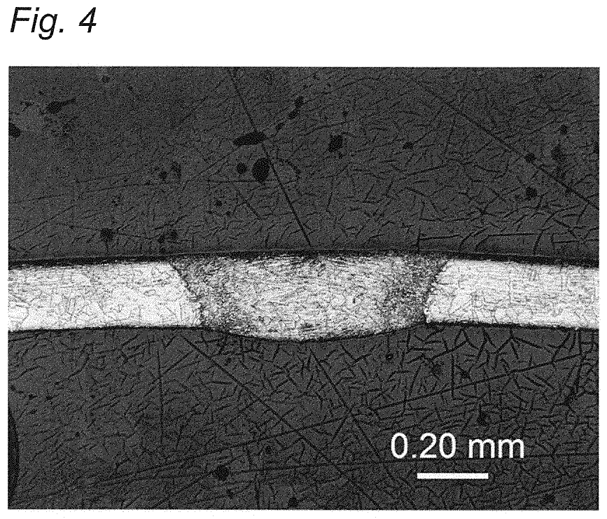

For example, as can be seen from the comparison between FIGS. 3 and 4 below, a welded pipe obtained by the manufacturing method of the present disclosure includes a weld metal with a narrow width and also has a uniform metal microstructure when observing a weld zone on the cross-section perpendicular to the axis of the welded pipe. In particular, when bright annealing is performed in a non-oxidizing atmosphere after manufacturing the welded pipe, the metal microstructure of the welded pipe becomes so uniform that a base metal part and the weld metal part are hardly distinguishable. Therefore, a further embodiment of the present invention (hereinafter sometimes referred to as “sixth embodiment”) is directed to a welded pipe which is composed of a stainless steel strip as the metal strip having a thickness of 0.15 mm or more and 0.25 mm or less, is seamless, and has a length of 60 m or more in the axial direction, and in which the width of the weld metal on the cross-section perpendicular to the axis of the welded pipe is 0.40 mm or more and 0.70 mm or less, and the weld metal on the cross-section does not have a linear microstructure and has a grain size equal to that of the base metal. The welded pipe in the sixth embodiment may include a welded pipe in which the discoloration due to oxidation is suppressed even without the bright annealing mentioned above.

The welded pipe (1) in the sixth embodiment is composed of a stainless steel strip as the metal strip having a thickness of 0.15 mm or more and 0.25 mm or less. The reasons for limiting the thickness of the stainless steel strip and the types of preferred metal materials have already been explained in the first embodiment, and its description is omitted here. The upper limit of the thickness in the first embodiment is 0.45 mm, whereas the upper limit of the thickness in the sixth embodiment is 0.25 mm. This upper limit is in compliance with the standard of welded pipes for gas piping made of stainless steel.

In the sixth embodiment, the welded pipe (1) is seamless and has a length of 60 m or more in the axial direction. The expression “seamless” refers to a state in which the welded pipe (1) has no marks indicative of welding on its cross-section perpendicular to the axial direction. That is, this means that a stainless steel strip of at least 60 m in length is continuously welded without stopping midway. In the sixth embodiment, the length of the welded pipe (1) according to the present disclosure in the axial direction only needs to be 60 m or more, and may be longer if the length of the stainless steel strip permits it, for example. However, the welded pipe (1) may be cut to an appropriate length for the convenience of handling and inspecting of the welded pipe.

In the sixth embodiment, the width of the weld metal on the cross-section perpendicular to the axis of the welded pipe (1) is 0.40 mm or more and 0.70 mm or less. The width of the weld metal refers to the length of the size of a portion of the weld metal on the cross-section perpendicular to the axis of the welded pipe (1), measured in the circumferential direction of the welded pipe (1). The width of the weld metal is generally wider on its outer peripheral surface side in contact with a heat source for the welding, and narrower on its inner peripheral surface side. Setting the width of the weld metal within the above-mentioned range in the welded pipe having a thickness of 0.15 mm or more and 0.25 mm or less is difficult to achieve in arc welding such as TIG welding, but is easy to achieve in the manufacturing method of the present disclosure using the laser welding. That is, the manufacturing method using the laser welding according to the present invention is able to achieve the welded pipe having the weld metal with such a narrow width for the first time.

In the sixth embodiment, the weld metal on the cross-section of the welded pipe (1) does not have a linear microstructure and has a grain size equal to that of the base metal. The linear microstructure is a microstructure specific to the weld metal formed by arc welding such as TIG welding. In the manufacturing method of the present disclosure using laser welding, it is considered that the weld metal does not have a linear microstructure with oxides precipitated because the formation of the molten pool and the formation of the weld metal by solidification are completed in a short time under the non-oxidizing atmosphere. Since the weld metal contains almost no impurities and has substantially the same composition as the base metal, the grain size of the weld metal after annealing is equal to the grain size of the base metal. Further, the manufacturing method using the laser welding according to the present disclosure is able to achieve the metal microstructure with such high uniformity in the weld metal of the welded pipe for the first time.

A welded pipe embodied as the above-mentioned welded pipe has an outer diameter of, for example, 10 mm or more and 40 mm or less.

While the embodiments of the invention of the welded pipe have been described above, the combination of the features of the welded pipe according to the present disclosure can only be achieved by the manufacturing method of a welded pipe according to the present disclosure. In other words, by observing the features of the metal microstructure on the cross-section of the welded pipe, it is possible to identify at a glance whether or not the welded pipe has been manufactured by the manufacturing method of a welded pipe according to the present disclosure.

### Seventh Embodiment

Another embodiment of the present invention is configured as the invention of a manufacturing device of a welded pipe. That is, another embodiment of the present invention (hereinafter sometimes referred to as “seventh embodiment”) is directed to a manufacturing device of a welded pipe that includes means for bending a stainless steel strip (1) as a metal strip having a thickness of 0.15 mm or more and 0.45 mm or less while conveying it to thereby form a pipe (1a), and means for welding a butting part of the formed pipe (1a) by irradiating the butting part with a laser beam (3) while applying compressive stress to the butting part by using a set of squeeze rolls (2), wherein an irradiation position (3c) of the laser beam is located on the upstream side in a pipe conveyance direction (1b) with respect to the position of a rotation axis (2a) of the squeeze roll, the size of the spot diameter of the laser beam (3) at the irradiation position (3c) is 0.60 mm or more and 1.2 mm or less, and the manufacturing device further includes a gas nozzle (4) for blowing inert gas at the butting part irradiated with the laser beam (3).

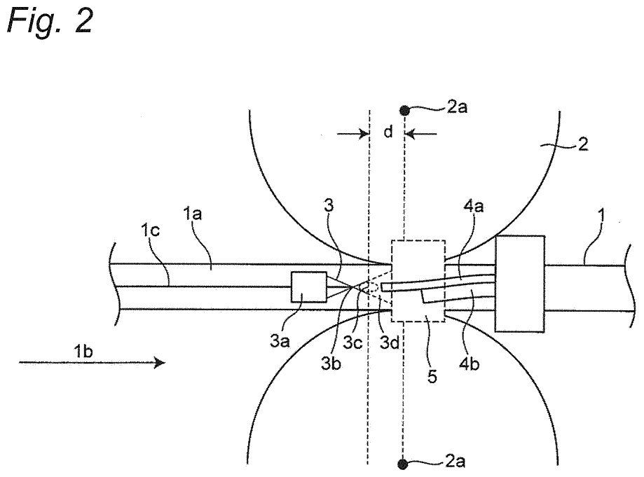

FIG. 1 is a schematic side view showing an example of the manufacturing device of a welded pipe according to the embodiment of the present invention. FIG. 2 is a schematic top view showing an example of the manufacturing device of a welded pipe according to the embodiment of the present invention. FIGS. 1 and 2 illustrate parts of the manufacturing device of a welded pipe of the seventh embodiment, excluding the means for bending the stainless steel strip while conveying it to form the pipe (1a). In FIGS. 1 and 2, the pipe (1a) formed by the bending is conveyed in the pipe conveyance direction (1b) from the left side to the right side of FIG. 1. The butting part (1c) of the formed pipe (1a) is located on the upper side of the pipe (1a) shown in FIG. 1. The compressive stress is applied to this butting part (1c) by the set of squeeze rolls (2). The rotation axis (2a) of the squeeze rolls is parallel to the vertical direction in FIG. 1. In FIG. 1, the illustration of the squeeze roll on the front side of the paper of FIG. 1 of the set of squeeze rolls (2) is omitted.

The laser beam (3) is emitted from the tip of the laser head (3a), which is located in the upper part of FIG. 1, toward the irradiation position (3c) at the butting part (1c) of the formed pipe (1a). The irradiation position (3c) of the laser beam is located on the upstream side in the pipe conveyance direction (1b) with respect to the position of the rotation axis (2a) of the squeeze roll, and the distance between both positions is denoted as d. The focal point (3b) of the laser beam is located between the position of the laser head (3a) and the irradiation position (3c) and spaced away from the position of a first gas nozzle to be mentioned later. The size of the spot diameter of the laser beam (3) at the irradiation position (3c) is 0.60 mm or more and 1.2 mm or less. The reflected light (3d) of the laser beam reflected at the irradiation position (3c) is absorbed by the laser beam receptor (5), which is located in the upper part of FIG. 1. In FIG. 2, the reflected light (3d) of the above-mentioned laser beam and the laser beam receptor (5) are shown by dashed lines to make it easier to recognize the first gas nozzle (4a) and the second gas nozzle (4b).

In the seventh embodiment, the manufacturing device of a welded pipe further includes a gas nozzle (4) for blowing inert gas at the butting part irradiated with the laser beam (3). In FIGS. 1 and 2, the first gas nozzle (4a) and the second gas nozzle (4b) having a diameter larger than that of the first gas nozzle are shown as the gas nozzles (4). The irradiation position (3c) of the laser beam, the position at which the inert gas is blown from the first gas nozzle (4a), and the position at which the inert gas is blown from the second gas nozzle (4b) are arranged in this order as viewed from the upstream side in the pipe conveyance direction in FIGS. 1 and 2. The first gas nozzle (4a) and the second gas nozzle (4b) are attached to a common header for supplying the inert gas. The reasons for limiting the individual configurations of the components in the manufacturing device of a welded pipe, the functions and effects given thereby, and the like in the seventh embodiment are the same as those in the case of the first embodiment, and thus the description thereof is omitted herein.

The schematic top view of FIG. 2 illustrates an embodiment in which the arrangement of the laser head (3a), the direction of the laser beam (3), and the direction of blowing the inert gas from the first gas nozzle (4a) and the second gas nozzle (4b) are all approximately parallel to the pipe conveyance direction (1b). However, the present disclosure is not limited to this embodiment. When the manufacturing device of a welded pipe is viewed from the top, for example, at least one of the direction of the laser beam (3) and the directions of blowing the inert gas from the first gas nozzle (4a) and the second gas nozzle (4b) can be inclined within the range from over 0 degree to ±45 degrees with respect to the pipe conveyance direction (1b).

In the seventh embodiment, the inert gas blown from the gas nozzle (4) stays in the surroundings of the irradiation position (3c) of the laser beam to form a non-oxidizing atmosphere. To maintain this non-oxidizing atmosphere more stably, it is preferable to enclose the irradiation position (3c) of the laser beam and the surroundings of the gas nozzle (4) with a wall (not shown). If the laser beam (3) and the laser beam receptor (5) are provided inside the wall, it can prevent the laser beam (3) from leaking to the outside of the wall, which is preferable from the viewpoint of the safety when operating the manufacturing device. Further, for the purpose of discharging some fumes generated from the molten pool to the outside, the gas inside the wall may be forced to be discharged through an exhaust port (not shown) provided in a part of the wall. In this case, an intake port may be provided in a part of the wall to avoid an area inside the wall from being at negative pressure. The intake port is preferably provided at the position where it does not interfere with the prevention of oxidation of the molten pool and the weld metal due to the inert gas.

### EXAMPLES

Embodiments for carrying out the present invention will be described in more detail with reference to the accompanying drawings by comparison between Examples and Comparative Examples.

### Example 1

A stainless steel strip having a thickness of 0.20 mm was bent by a plurality of rolls while being conveyed to thereby form the pipe (1a) having an outer diameter of about 24 mm. The butting part (1c) of the formed pipe (1a) was irradiated with the laser beam (3) using the manufacturing device shown in FIG. 1, while applying the compressive stress to the butting part (1c) by using the set of squeeze rolls (2). The light source of the laser beam (3) was an YAG laser, and its output was 2 kW. The speed at which the formed pipe (1a) was conveyed was 8.5 meters per minute. The spot diameter of the laser beam (3) was about 0.9 mm, and the irradiation position (3c) of the laser beam was spaced apart by 2.0 mm or more and 3.0 mm or less from the position of the surface of the butting part of the pipe (1a) including the rotation axis (2a) of the squeeze roll, in the direction opposite to the conveyance direction (1b) of the stainless steel strip, i.e., on the upstream side. The direction of irradiation of the laser beam (3) was inclined at the angle θ3=about 12 degrees toward the upstream side with respect to the X direction perpendicular to the pipe conveyance direction (1b), and the focal point (3b) of the laser beam was located between the position of the laser head (3a) and the irradiation position (3c). The reflected light (3d) reflected by the surface of the butting part of the pipe (1a) was absorbed by the laser beam receptor (5) cooled with cooling water. It is noted that in Example 1, the angle θ1 formed by the direction in which the inert gas was blown from the first gas nozzle (4a) and the direction opposite to the pipe conveyance direction (1b) was set to about 40 degrees. Further, the angle θ2 formed by the direction in which the inert gas was blown from the second gas nozzle (4b) and the direction opposite to the pipe conveyance direction (1b) was set to about 20 degrees.

The weld pool formed by irradiation with the laser beam (3) was cooled and solidified by argon gas blown from the first gas nozzle (4a) having a diameter (inner diameter) of 3.0 mm, and compressive stress was applied by the set of squeeze rolls (2) to thereby obtain the welded pipe (1). The flow rate of argon gas blown from the first gas nozzle (4a) was approximately 2 liters per minute. The position where the gas from the first gas nozzle (4a) was blown was the irradiation position (3c) of the laser beam. The atmosphere here was controlled such that no air was entrained in the gas blown from the first gas nozzle (4a) by supplying argon gas from the second gas nozzle (4b) as well, which had a diameter (inner diameter) of 8.0 mm and was provided behind the first gas nozzle (4a). The flow rate of argon gas blown from the second gas nozzle (4b) was approximately 12 liters per minute. Almost no fumes were generated from the molten pool in the laser welding, and the weld metal part of the resulting welded pipe (1) showed almost no discoloration due to oxidation. The resulting welded pipe (1) was subjected to a corrugation process using a rotating die (not shown), followed by bright annealing which included heating and holding at 1080° C. in a hydrogen atmosphere and then cooling, thereby obtaining a seamless stainless steel flexible pipe having a total length of 60 m. A part of the resulting flexible pipe was cut, and its cross-section perpendicular to the length direction, including the weld metal, was filled with resin, followed by mirror polishing, and etched with nitar. Then, the metal microstructure on the cross-section was observed using an optical microscope. FIG. 3 shows a photograph taken of the cross-sectional microstructure of the weld zone in the welded pipe.

The upper side of FIG. 3 shows the outer peripheral surface of the welded pipe (1), while the lower side thereof shows its inner peripheral surface. A slightly thick part located at the center in FIG. 3 is a part of the weld metal formed by the laser welding. The width of the weld metal in the lateral direction was 0.67 mm on the outer peripheral surface side and 0.51 mm on the inner peripheral surface side. While the thickness of the base metal of the welded pipe (1) was 0.20 mm, the maximum thickness of the weld metal was 0.25 mm, which was 125% of the thickness of the base metal. The weld metal on the cross-section did not have any linear microstructure and had a grain size equal to that of the base metal. That is, the recrystallization of austenite phases which were formed by annealing and grown into a relatively large size appeared in both the base metal and weld metal parts, and the metal microstructures of both parts were so uniform that they were not able to be distinguished from each other. The Vickers hardness of the base metal part was 152, and the Vickers hardness of the weld metal part was 156, with a difference in the Vickers hardness between both parts being 4. There was almost no discoloration due to oxidation on the surface of the weld metal part of the resulting welded pipe (1).

### Comparative Example 1

A stainless steel strip having a thickness of 0.20 mm was bent by a plurality of rolls and shoes while being conveyed to thereby form a pipe (1a) having an outer diameter of about 24 mm. A butting part of the formed pipe (1a) was welded by the TIG welding under an argon atmosphere to obtain a welded pipe (1). The speed at which the formed pipe (1a) was conveyed was 7.0 meters per minute. The resulting welded pipe (1) was subjected to a corrugation process using a rotating die, followed by bright annealing which included heating and holding at 1080° C. in a hydrogen atmosphere and then cooling, thereby obtaining a seamless stainless steel flexible pipe having a total length of 60 m. A part of the resulting flexible pipe was cut, and its cross-section perpendicular to the length direction, including the weld metal, was filled with resin, followed by mirror polishing, and etched with nitar. Then, the metal microstructure on the cross-section was observed using an optical microscope. FIG. 4 shows a photograph taken of the cross-sectional microstructure of the weld zone in the welded pipe.

The upper side of FIG. 4 shows the outer peripheral surface of the welded pipe (1), while the lower side thereof shows its inner peripheral surface. A thick part located at the center in FIG. 4 is a part of the weld metal formed by the TIG welding. The width of the weld metal in the lateral direction was 0.79 mm on the outer peripheral surface side and 0.62 mm on the inner peripheral surface side. While the thickness of the base metal of the welded pipe 2 was 0.20 mm, the maximum thickness of the weld metal was 0.25 mm, which was 125% of the thickness of the base metal. The region of the weld metal on the cross-section located close to the base metal and the regions of the weld metal thereon close to its outer peripheral surface and inner peripheral surface each showed a linear microstructure containing fine dendritic crystals, and these regions had a crystal microstructure that was completely different from the crystal microstructure of the base metal part. A recrystallized microstructure of an austenite phase was observed at the central part of the weld metal, but its grain size was obviously smaller than that of the recrystallized microstructure of the base metal part. That is, the base metal part and the weld metal part were seen to be clearly different in terms of the metal microstructure. The Vickers hardness of the base metal part was 162, and the Vickers hardness of the weld metal part was 169, with a difference in the Vickers hardness between both parts being 7.

From Example 1, it can be seen that the manufacturing method according to the present disclosure can stably manufacture welded pipes (1) with the occurrence of a linear microstructure suppressed at high speed for a long time using a stainless steel strip having a thickness of 0.20 mm. When comparing the results of Example 1 and Comparative Example 1, it can be seen that in the welded pipe manufactured by the laser welding according to the present disclosure, the weld metal and the base metal have similar metal microstructures, and thus those metal microstructures of the weld metal and the base metal are so uniform that they cannot be distinguished from each other, unlike in the welded pipe manufactured by the conventional TIG welding. The TIG welding must replace welding electrodes by pausing the line, depending on the wear of the welding electrode. In contrast, the laser welding does not need such a replacement and is advantageous also in terms of the production efficiency.

### Example 2

Under the same conditions as those in Example 1, the welding pipe (1) was manufactured while blowing argon gas only from the first gas nozzle (4a) without blowing argon gas from the second gas nozzle (4b). Almost no fumes were generated from the molten pool in the laser welding, but discoloration due to oxidation was found on the surface of the weld metal part of the resulting welded pipe (1).

### Comparative Example 2

Under the same conditions as those in Example 1, the welding pipe (1) was manufactured while blowing argon gas only from the second gas nozzle (4b) without blowing argon gas from the first gas nozzle (4a). A large amount of fumes was generated from the molten pool in laser welding, and the generated fumes adhered to and accumulated on the squeeze roll (2) and other parts, making continuous manufacturing difficult. There was almost no discoloration due to oxidation on the surface of the weld metal part of the resulting welded pipe (1).

### Comparative Example 3

Under the same conditions as those in Example 1, the welding pipe (1) was manufactured without blowing argon gas from either the first or second gas nozzle. A large amount of fumes was generated from the molten pool in laser welding, and the generated fumes adhered to and accumulated on the squeeze roll (2) and other parts, making continuous manufacturing difficult. There was discoloration due to oxidation on the surface of the weld metal part of the resulting welded pipe (1). When observing the metal microstructures of the cross-sections of the welded pipes (1) of Example 2, Comparative Example 2, and Comparative Example 3, they were not much different from the metal microstructure of Example 1.

When comparing the results of Example 1, Example 2, Comparative Example 2, and Comparative Example 3, it can be seen that the spaying of inert gas from the first gas nozzle is effective in order to manufacture a welded pipe that has an uniform metal microstructure at high speed by synchronizing the timing of cooling and solidifying of the molten pool with the timing of applying compressive stress by using the squeeze rolls (2), while suppressing the generation of fumes from the molten pool in the laser welding. It can also be seen that blowing inert gas from the second gas nozzle is effective in preventing discoloration due to oxidation of the surface of the weld metal part of the welded pipe (1). As in Example 2, if the inert gas is blown from the first gas nozzle only, the generation of fumes can be suppressed to continuously perform the laser welding, but further by blowing the inert gas from the second gas nozzle as well, discoloration due to oxidation of the surface of the weld metal part can be prevented, whereby the welded pipe (1) with excellent appearance can be obtained.

This application claims priority based on Japanese Patent Application No. 2019-060259, the disclosure of which is incorporated by reference herein.

The disclosure of the present specification includes the following aspects which correspond to claims of the basic application.

### First Aspect:

A manufacturing method of a welded pipe, which includes: bending a metal strip having a thickness of 0.15 mm or more and 0.45 mm or less while conveying the metal strip in one direction to thereby form a pipe (1a); and welding a butting part of the formed pipe (1a) by irradiating the butting part with a laser beam (3) while applying compressive stress to the butting part by using a set of squeeze rolls (2),

wherein an irradiation position (3c) of the laser beam is located on an upstream side in a pipe conveyance direction (1b) with respect to a position of a rotation axis (2a) of the squeeze roll,

a size of a spot diameter of the laser beam (3) at the irradiation position (3c) is 0.60 mm or more and 1.2 mm or less, and

inert gas is blown from a gas nozzle (4) at the butting part irradiated with the laser beam (3).

### Second Aspect:

The manufacturing method of a welded pipe according to the first aspect, wherein the inert gas includes inert gas blown from a first gas nozzle (4a) and inert gas blown from a second gas nozzle (4b) that has a diameter larger than that of the first gas nozzle.

### Third Aspect:

The manufacturing method of a welded pipe according to the second aspect, wherein the irradiation position (3c), a position at which the inert gas is blown from the first gas nozzle (4a), and a position at which the inert gas is blown from the second gas nozzle (4b) are arranged at the butting part in this order.

### Fourth Aspect:

The manufacturing method of a welded pipe according to any one of the first to third aspects, wherein a position of a laser head (3a) is located on an upstream side in the pipe conveyance direction (1b) with respect to the irradiation position (3c), and a focal point (3b) of the laser beam is located between the position of the laser head (3a) and the irradiation position (3c).

### Fifth Aspect:

The manufacturing method of a welded pipe according to any one of the first to fourth aspects, wherein reflected light (3d) of the laser beam is absorbed by a laser beam receptor (5).

### Sixth Aspect:

A welded pipe composed of a metal strip having a thickness of 0.15 mm or more and 0.25 mm or less, the welded pipe being seamless and having a length of 60 m or more in an axial direction,

wherein a width of a weld metal on a cross-section perpendicular to an axis of the welded pipe is 0.40 mm or more and 0.70 mm or less, and

the weld metal on the cross-section does not have a linear microstructure and has a grain size equal to a grain size of a base metal.

### Seventh Aspect:

A manufacturing device of a welded pipe, which includes: means for bending a metal strip (1) having a thickness of 0.15 mm or more and 0.45 mm or less while conveying the metal strip to thereby form a pipe (1a); and means for welding a butting part of the formed pipe (1a) by irradiating the butting part with a laser beam (3) while applying compressive stress to the butting part by using a set of squeeze rolls (2),

wherein an irradiation position (3c) of the laser beam is located on an upstream side in a pipe conveyance direction (1b) with respect to a position of a rotation axis (2a) of the squeeze roll,

a size of a spot diameter of the laser beam (3) at the irradiation position (3c) is 0.60 mm or more and 1.2 mm or less, and

the manufacturing device further includes a gas nozzle (4) for blowing inert gas at the butting part irradiated with the laser beam (3).

### DESCRIPTION OF REFERENCE SYMBOLS

1 Welded pipe

1a Pipe

1b Pipe conveyance direction

1c Butting part of the pipe

2 Squeeze roll

2a Rotation axis of the squeeze roll

3 Laser beam

3a Laser head

3b Focal point

3c Irradiation position

3d Reflected light

4 Gas nozzle

4a First gas nozzle

4b Second gas nozzle

5 Laser beam receptor

d Distance from the irradiation position to the position of the rotation axis of the squeeze roll

X Direction perpendicular to the butting part of the pipe

1. A manufacturing method of a welded pipe, which comprises: bending a stainless steel strip having a thickness of 0.15 mm or more and 0.45 mm or less while conveying the stainless steel strip in one direction to thereby form a pipe; and welding a butting part of the formed pipe by irradiating the butting part with a laser beam while applying compressive stress to the butting part by using a set of squeeze rolls,
wherein an irradiation position of the laser beam is located on an upstream side in a pipe conveyance direction with respect to a position of a rotation axis of the squeeze roll,
a size of a spot diameter of the laser beam at the irradiation position of the laser beam is 0.60 mm or more and 1.2 mm or less, and
inert gas is blown from a gas nozzle at the butting part irradiated with the laser beam.

2. The manufacturing method of a welded pipe according to claim 1,
wherein the gas nozzle includes a first gas nozzle and a second gas nozzle having a diameter larger than that of the first gas nozzle, and
the inert gas includes inert gas blown from the first gas nozzle and inert gas blown from the second gas nozzle.

3. The manufacturing method of a welded pipe according to claim 2,
wherein the irradiation position of the laser beam, a position at which the inert gas is blown from the first gas nozzle, and a position at which the inert gas is blown from the second gas nozzle are arranged at the butting part in this order as viewed from the upstream side in the pipe conveyance direction.

4. The manufacturing method of a welded pipe according to claim 1,
wherein a position at which the inert gas is blown on the butting part from the gas nozzle is located within an area from the irradiation position of the laser beam to the position of the rotation axis of the squeeze roll.

5. The manufacturing method of a welded pipe according to claim 1,
wherein an angle θ1 formed by a direction in which the inert gas is blown from the gas nozzle and a direction opposite to the pipe conveyance direction is 25 degrees or more and 65 degrees or less.

6. The manufacturing method of a welded pipe according to claim 1,
wherein a flow rate of the inert gas blown from the gas nozzle is 1.0 liter per minute or more and 20 liters per minute or less.

7. The manufacturing method of a welded pipe according to claim 1,
wherein a distanced from the irradiation position of the laser beam to the position of the rotation axis of the squeeze roll in a direction parallel to the pipe conveyance direction is within a range of 0.5 mm or more and 5.0 mm or less.

8. The manufacturing method of a welded pipe according to claim 1,
wherein a position of a laser head for irradiation of the laser beam is located on an upstream side in the pipe conveyance direction with respect to the irradiation position of the laser beam, and a focal point of the laser beam is located between the position of the laser head and the irradiation position of the laser beam.

9. The manufacturing method of a welded pipe according to claim 1,
wherein reflected light of the laser beam is absorbed by a laser beam receptor.

10. The manufacturing method of a welded pipe according to claim 1,
wherein the bending of the stainless steel strip is performed using a roll.

11. A manufacturing device of a welded pipe, comprising:
means for bending a stainless steel strip having a thickness of 0.15 mm or more and 0.45 mm or less while conveying the stainless steel strip to thereby form a pipe; and means for welding a butting part of the formed pipe by irradiating the butting part with a laser beam while applying compressive stress to the butting part by using a set of squeeze rolls,
wherein an irradiation position of the laser beam is located on an upstream side in a pipe conveyance direction with respect to a position of a rotation axis of the squeeze roll,
a size of a spot diameter of the laser beam at the irradiation position of the laser beam is 0.60 mm or more and 1.2 mm or less, and
the manufacturing device further includes a gas nozzle for blowing inert gas at the butting part irradiated with the laser beam, and
a position at which the inert gas is blown on the butting part from the gas nozzle is located within an area from the irradiation position of the laser beam to the position of the rotation axis of the squeeze roll.

12. The manufacturing device of a welded pipe according to claim 11,
wherein the gas nozzle includes a first gas nozzle and a second gas nozzle having a diameter larger than that of the first gas nozzle.

13. The manufacturing method of a welded pipe according to claim 2,
wherein a position at which the inert gas is blown on the butting part from the first gas nozzle is located within an area from the irradiation position of the laser beam to the position of the rotation axis of the squeeze roll.

14. The manufacturing method of a welded pipe according to claim 2,
wherein an angle θ1 formed by a direction in which the inert gas is blown from the first gas nozzle and a direction opposite to the pipe conveyance direction is 25 degrees or more and 65 degrees or less.

15. The manufacturing method of a welded pipe according to claim 2,
wherein a flow rate of the inert gas blown from the first gas nozzle is 1.0 liter per minute or more and 20 liters per minute or less.

16. The manufacturing method of a welded pipe according to claim 2,
wherein a distanced from the irradiation position of the laser beam to the position of the rotation axis of the squeeze roll in a direction parallel to the pipe conveyance direction is within a range of 0.5 mm or more and 5.0 mm or less.

17. The manufacturing method of a welded pipe according to claim 2,
wherein a position of a laser head for irradiation of the laser beam is located on an upstream side in the pipe conveyance direction with respect to the irradiation position of the laser beam, and
a focal point of the laser beam is located between the position of the laser head and the irradiation position of the laser beam.

18. The manufacturing method of a welded pipe according to claim 2,
wherein reflected light of the laser beam is absorbed by a laser beam receptor.

19. The manufacturing method of a welded pipe according to claim 2,
wherein the bending of the stainless steel strip is performed using a roll.
